(19) United States
(12) Patent Application Publication
(10) Pub. No.: US 2012/0307947 A1
(43) Pub. Date: Dec. 6, 2012

(54) SIGNAL PROCESSING CIRCUIT, WIRELESS COMMUNICATION DEVICE, AND SIGNAL PROCESSING METHOD

(76) Inventor: Hiroshi Kodama, Tokyo (JP)

(21) Appl. No.: 13/578,149

(22) PCT Filed: Dec. 20, 2010
(86) PCT No.: PCT/JP2010/007366

§ 371 Date: Aug. 9, 2012

(30) Foreign Application Priority Data
Feb. 25, 2010 (JP) 2010-039903

(51) Int. Cl. H04L 27/06

(52) U.S. Cl. 375/344

(57) ABSTRACT

An exemplary object is to provide a signal processing circuit, a wireless communication device, and a signal processing method for reducing crosstalk of an adjacent interfering signal in a desired signal. A signal processing circuit 3 according to the present invention includes a power acquisition unit 4 that receives multiple radio signals transmitted with different frequency bands and acquires power intensities of the received radio signals; and a frequency selection unit 5 that selects, from among frequency bands used for radio signals having the power intensity lower than a predetermined power intensity, a frequency band having a relatively low power intensity in a frequency band near the frequency bands as each frequency band in which communication is executed.

### TECHNICAL FIELD

The present invention relates to a signal processing circuit, a wireless communication device, and a signal processing method, and more particularly, to a signal processing circuit, a wireless communication device, and a signal processing method which receive a plurality of radio signals transmitted with different frequency bands.

### BACKGROUND ART

In general, radio signals received via a wireless communication line include a desired signal in which data to be processed by a receiver is set and an adjacent interfering signal. The adjacent interfering signal has a frequency set to be adjacent to the frequency that is set to the desired signal. Accordingly, a study has been made on a method for controlling a signal processing circuit according to the power intensity of a received adjacent interfering signal in order to avoid crosstalk between the desired signal and the adjacent interfering signal and reduce a loss of desired signal components.

Patent Literature 1 discloses a receiver that adjusts the bandwidth of a filter according to the power intensity of a detected adjacent interfering signal. The configuration of the receiver disclosed in Patent Literature 1 is described with reference to FIG. 18. This receiver is configured by connecting an antenna 210, an analog processing unit (AFE) 220, an AD (Analog Digital) converter (ADC) 230, a digital processing unit (DSP) 240, and an energy detection unit (Energy Det) 250 in this order from the signal input side. At this time, a digital circuit is used as the energy detection unit 250.

Next, operation of the receiver disclosed in Patent Literature 1 will be described. First, the desired signal and the adjacent interfering signal are converted into digital signals by the AD converter 230 via the antenna 210 and the analog processing unit 220. These digital signals are output to the energy detection unit 250 via the digital processing unit 240 to calculate the power intensity of the adjacent interfering signal. When this power intensity is high, the bandwidth of a digital filter within the digital processing unit 220 is decreased to thereby avoid crosstalk between the desired signal and the adjacent interfering signal. When this power intensity is low, the bandwidth of the digital filter is increased to thereby reduce a loss of the desired signal components. The use of such a configuration enables the receiver to perform stable communication, independently of the power intensity of the interfering signal.

Patent Literature 2 discloses a method for controlling a sampling frequency in an AD converter according to the power intensity of a detected interfering signal. When the power intensity of the detected interfering signal is high, the receiver increases the sampling frequency. When the power intensity of the interfering signal is low, the receiver reduces the sampling frequency. When the power intensity of the interfering signal is low, the sampling frequency is reduced, thereby making it possible to reduce the power consumption in the AD converter.

Patent Literature 3 discloses a receiving device that switches optimum filter characteristics according to the power intensity of a detected interfering signal, and carries out AFC (automatic frequency control). The switching of the optimum filter characteristics is executed by controlling the passband width and damping property of a filter.

### CITATION LIST

### Patent Literature

[Patent Literature 1] Japanese Unexamined Patent Application Publication No. 2009-60273
[Patent Literature 2] Japanese Unexamined Patent Application Publication No. 2009-159210
[Patent Literature 3] Japanese Unexamined Patent Application Publication No. 2009-200571

### SUMMARY OF INVENTION

### Technical Problem

In the receiving devices disclosed in Patent Literatures 1 to 3, however, the desired signal is greatly influenced by the adjacent interfering signal when the power intensity of the adjacent interfering signal is large. As a result, crosstalk occurs between the adjacent interfering signal and the desired signal. Thus, there is a problem that as the power intensity of the adjacent interfering signal increases, it may become more difficult to eliminate the influence of the crosstalk due to the interfering signal, by using the filter or the like within the receiving device.

The present invention has been made to solve the above-mentioned problem, and an object of the present invention is to provide a signal processing circuit, a wireless communication device, and a signal processing method which reduce crosstalk of an adjacent interfering signal in a desired signal.

### Solution to Problem

A signal processing circuit according to a first aspect of the present invention includes: a power acquisition unit that receives a plurality of radio signals transmitted with different frequency bands and acquires a power intensity of each of the radio signals received; and a frequency selection unit that selects, from among frequency bands used for radio signals having the power intensity lower than a predetermined power intensity, a frequency band having a relatively low power intensity in a frequency band near the frequency bands as each frequency band in which communication is executed.

A wireless communication device according to a second aspect of the present invention includes: a power acquisition unit that receives a plurality of radio signals transmitted with different frequency bands and acquires a power intensity of each of the radio signals received; a frequency selection unit that selects, from among frequency bands used for radio signals having the power intensity lower than a predetermined power intensity, a frequency band having a relatively low power intensity in a frequency band near the frequency bands as each frequency band in which communication is executed; and a communication unit that notifies a counterpart communication device of the selected frequency band.

A signal processing method according to a third aspect of the present invention includes the steps of receiving a plurality of radio signals transmitted with different frequency bands and acquiring a power intensity of each of the radio signals received; and selecting, from among frequency bands used for radio signals having the power intensity lower than a predetermined power intensity, a frequency band having a relatively low power intensity in a frequency band near the frequency bands as each frequency band in which communication is executed.

### Advantageous Effects of Invention

According to the present invention, it is possible to provide a signal processing circuit, a wireless communication device, and a signal processing method which reduce crosstalk of an adjacent interfering signal in a desired signal.

### BRIEF DESCRIPTION OF DRAWINGS

FIG. 1 is a block diagram of a wireless communication device according to a first exemplary embodiment;

FIG. 2 is a block diagram of a signal processing circuit according to the first exemplary embodiment;

FIG. 3 is a block diagram of the signal processing circuit according to the first exemplary embodiment;

FIG. 4 is a block diagram of an energy detection unit according to the first exemplary embodiment;

FIG. 5 is a block diagram of the energy detection unit according to the first exemplary embodiment;

FIG. 6 is a block diagram of an oscillator according to the first exemplary embodiment;

FIG. 7 is a block diagram of the oscillator according to the first exemplary embodiment;

FIG. 8 is a block diagram of a variable filter according to the first exemplary embodiment;

FIG. 9 is a graph showing relations between frequencies and power according to the first exemplary embodiment;

FIG. 10 is a flow chart relating to the determination of a desired signal frequency according to the first exemplary embodiment;

FIG. 11 is a data table that correlates frequencies with power intensities according to the first exemplary embodiment;

FIG. 12 is a data table that correlates frequencies with power intensities according to the first exemplary embodiment;

FIG. 13 is a block diagram of a signal processing circuit according to a second exemplary embodiment;

FIG. 14 is a block diagram of an oscillator according to the second exemplary embodiment;

FIG. 15 is a block diagram of a signal processing circuit according to a third exemplary embodiment;

FIG. 16 is a block diagram of an AD converter according to the third exemplary embodiment;

FIG. 17 is a block diagram of the AD converter according to the third exemplary embodiment; and

FIG. 18 is a block diagram of a receiver disclosed in Patent Literature 1.

### DESCRIPTION OF EMBODIMENTS

### First Exemplary Embodiment

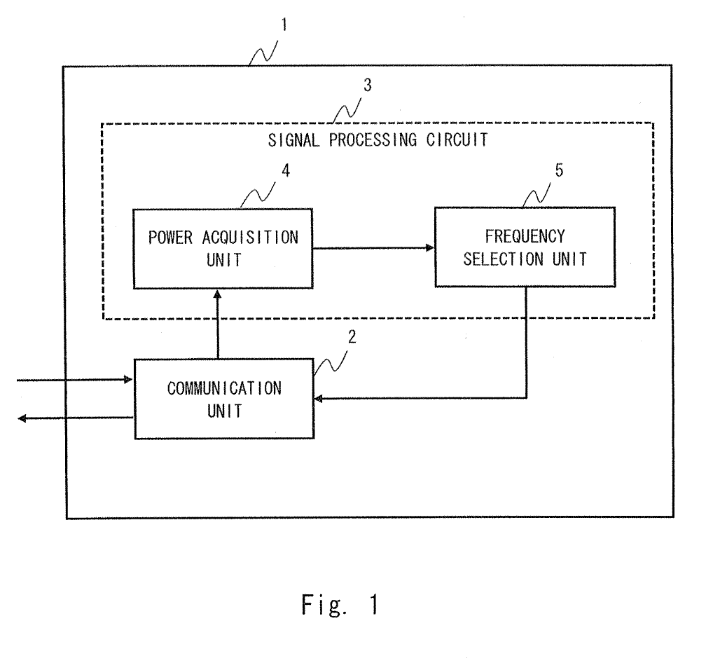

Hereinafter, exemplary embodiments of the present invention will be described with reference to the drawings. A configuration example of a wireless communication device 1 according to a first exemplary embodiment of the present invention will be described with reference to FIG. 1. The wireless communication device 1 includes a communication unit 2 and a signal processing circuit 3. Further, the communication unit 2 includes a power acquisition unit 4 and a frequency selection unit 5.

The communication unit 2 acquires radio signals transmitted from a device that executes communication with the wireless communication device 1. Examples of the device that executes communication include a mobile phone terminal. The communication unit 2 outputs the acquired radio signal to the power acquisition unit 4.

The power acquisition unit 4 acquires a plurality of radio signals from the communication unit 2. The radio signals are transmitted from a mobile phone terminal or the like by using different frequency bands. The power acquisition unit 4 acquires the power intensity of each of the received radio signals. Examples of the power intensity include transmitted power set by the mobile phone terminal or the like, and received power detected when the wireless communication device 1 receives a radio signal. The power acquisition unit 4 may be notified of a transmitted power value from the mobile phone terminal or the like, or may measure the received power of each radio signal acquired by the communication unit 2 to thereby detect the received power. The power acquisition unit 4 outputs the acquired power intensity to the frequency selection unit 5.

The frequency selection unit 5 extracts the radio signal, the received power intensity of which is lower than a predetermined power intensity. This enables extraction of a frequency band used for the radio signal having a power intensity lower than the predetermined power intensity (hereinafter, “threshold power”). For example, “0” is set as the threshold power. As a result, data transmission is not executed in the frequency band in which the power intensity is “0”, that is, no power intensity is detected, so it is possible to determine the frequency band as a free space.

The frequency selection unit 5 selects, from among frequency bands used for the extracted radio signal, a frequency band having a relatively low power intensity in a frequency band near the frequency bands as each frequency band in which communication is executed. The nearby frequency bands include a plurality of frequency bands such as adjacent frequency bands and frequency bands adjacent to the adjacent frequency bands. The frequency selection unit 5 outputs information on the selected frequency bands to the communication unit 2. The communication unit 2 notifies the mobile phone terminal or the like of the acquired information on the frequency bands, and executes communication using the selected frequency bands.

As described above, the use of the signal processing circuit according to the first exemplary embodiment of the present invention enables acquisition of the power intensity in each frequency band. Furthermore, the use of the acquired frequency bands enables selection of frequency bands, which are less affected by the radio signals set to the nearby frequency bands, as the frequency bands in which communication is executed. The notification of the selected frequency bands to the mobile phone terminal or the like enables execution of wireless communication which is less affected by the radio signals set to the nearby frequency bands.

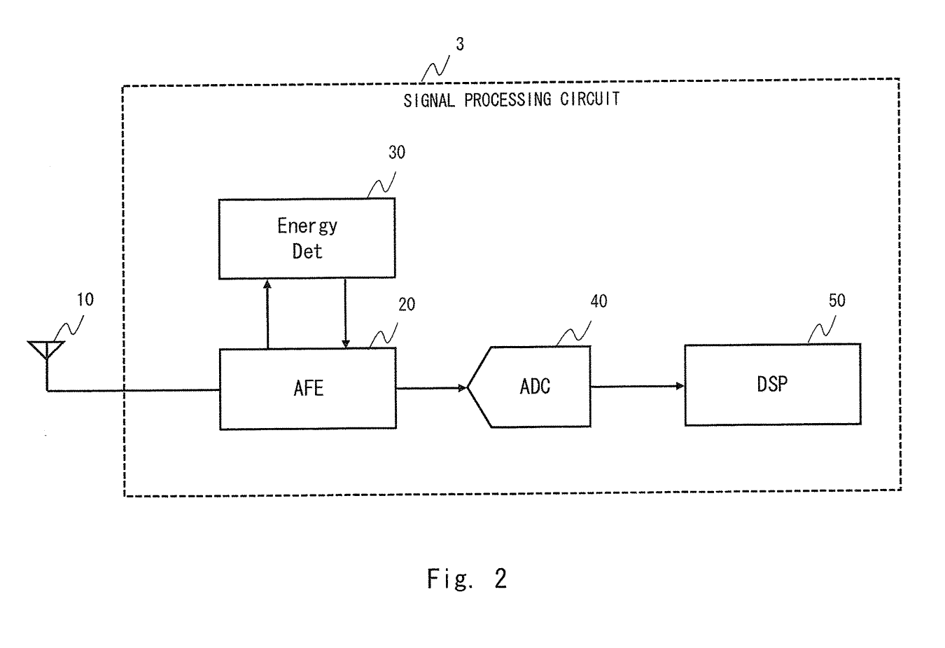

Subsequently, a detailed configuration example of the signal processing circuit 3 according to the first exemplary embodiment of the present invention will be described with reference to FIG. 2. The signal processing circuit 3 includes an analog processing unit (AFE) 20, an energy detection unit (Energy Det) 30, an AD converter (ADC) 40, and a digital processing unit (DSP) 50. The analog processing unit 20 is connected to an antenna 10. The power acquisition unit 4 and the frequency selection unit 5 correspond to the energy detection unit 30.

The analog processing unit 20 executes amplification of the amplitude of each radio signal acquired via the antenna 10, and filter control to extract a desired signal for executing communication, for example. Further, the analog processing unit 20 adjusts the amplification of the amplitude and the filter control, for example, according to the control signal notified from the energy detection unit 30. Furthermore, the analog processing unit 20 outputs the radio signal subjected to an analog signal processing to the AD converter 40. Further, the analog processing unit 20 outputs the radio signals acquired via the antenna 10 to the energy detection unit 30.

The energy detection unit 30 detects a plurality of radio signals output from the analog processing unit 20, and selects a frequency band to be used for the desired signal.

The AD converter 40 converts the signal received from the analog processing unit 20 into a digital signal, and outputs the digital signal to the digital processing unit 50. The digital processing unit 50 executes filtering control or the like with a digital filter by using the received digital signal, and performs digital signal processing.

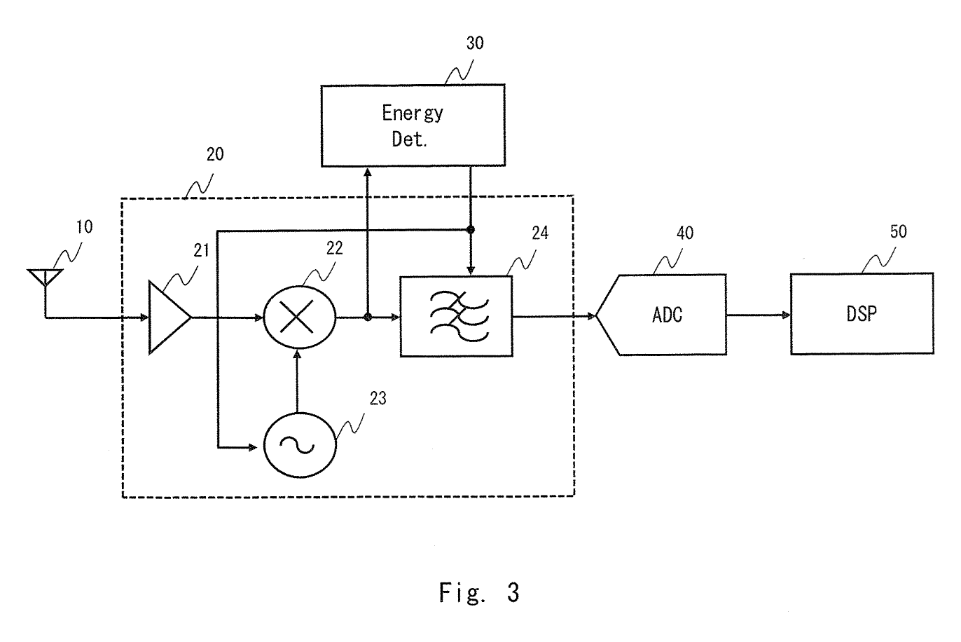

Subsequently, a detailed configuration example of the signal processing circuit 3 according to the first exemplary embodiment of the present invention will be described with reference to FIG. 3. The analog processing unit 20 described with reference to FIG. 1 includes an amplifier 21, a mixer 22, an oscillator 23, and a variable filter 24. The amplifier 21 amplifies small signals received from the antenna 10. The mixer 22 converts an output signal frequency of the amplifier 21 into a difference frequency signal between the output signal frequency of the amplifier 21 and a local signal frequency generated by the oscillator 23. The variable filter 24 limits the band of each signal output from the mixer 22, thereby eliminating signal components of out-of-band frequencies. The energy detection circuit 30 receives the output signal of the mixer 22 and outputs a control signal to the variable filter 24. Further, the energy detection unit 30 outputs a signal for controlling a variable frequency value, which is output from the oscillator 23, to the oscillator 23. The AD converter 40 and the digital processing unit 50 are similar to those shown in FIG. 2, so the description thereof is omitted. In FIG. 3, the variable filter 24 is disposed only between the mixer 22 and the AD converter 40, but the variable filter may also be disposed between the amplifier 21 and the mixer 22. In this case, the energy detection unit 30 outputs control signals to these two variable filters.

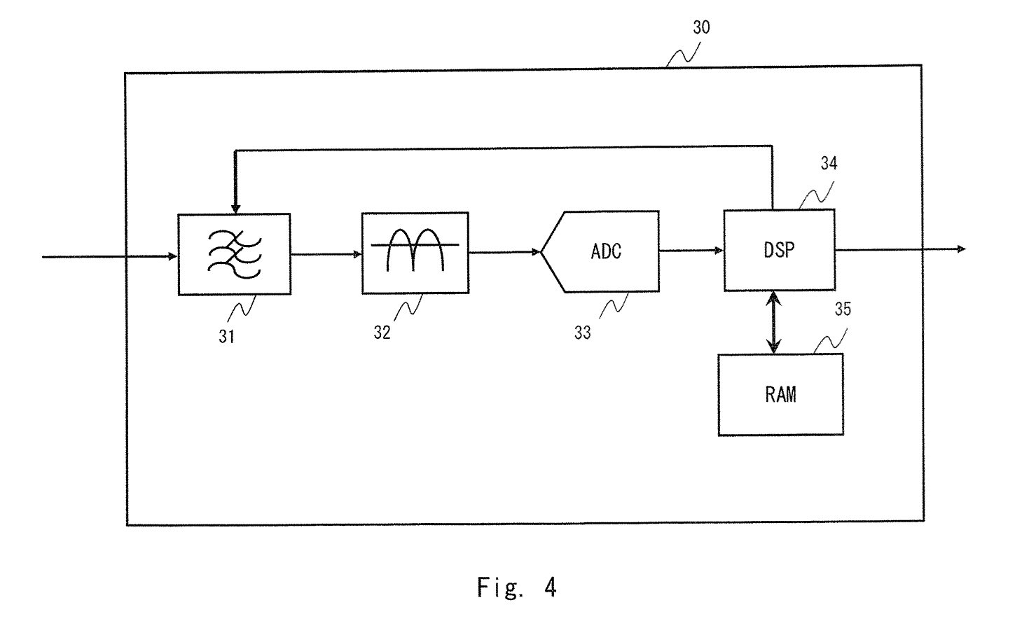

Subsequently, a configuration example of the energy detection unit 30 according to the first exemplary embodiment of the present invention will be described with reference to FIG. 4. The energy detection unit 30 includes a variable filter 31, a square-law detection unit 32, an AD converter (ADC) 33, a digital processing unit (DSP) 34, and a memory (RAM) 35. The band of the variable filter 31 is switched by the digital control signal output from the digital processing unit 34, and the band of the signal input to the square-law detection unit 32 is limited. In general, energy detection can be performed at higher speed by increasing the band of the variable filter 31, while the energy detection can be performed at higher sensitivity by decreasing the band of the variable filter 31. That is, decreasing the band of the variable filter 31 enables detection of small energy.

The square-law detection unit 32 detects energy by an analog operation using an integrator, for example. The energy is used as the same meaning as a signal intensity. The analog output signal of the square-law detection unit 32 is converted into a digital signal by the AD converter 33. In the digital processing unit 34, digital signal processing for generating a control signal for controlling the analog processing unit 20 according to the signal intensity can be performed. The digital processing unit 34 writes the results of the digital signal processing into the memory 35 and stores the results, thereby making is possible to compile a database for a plurality of trial results of the energy detection. Accordingly, it is possible to generate the control signal depending on the plurality of energy detection results by referring to this database. Note that the reason for using such digital signal processing is that when the recent fine CMOS process is employed, this fine CMOS process is highly compatible with digital circuits.

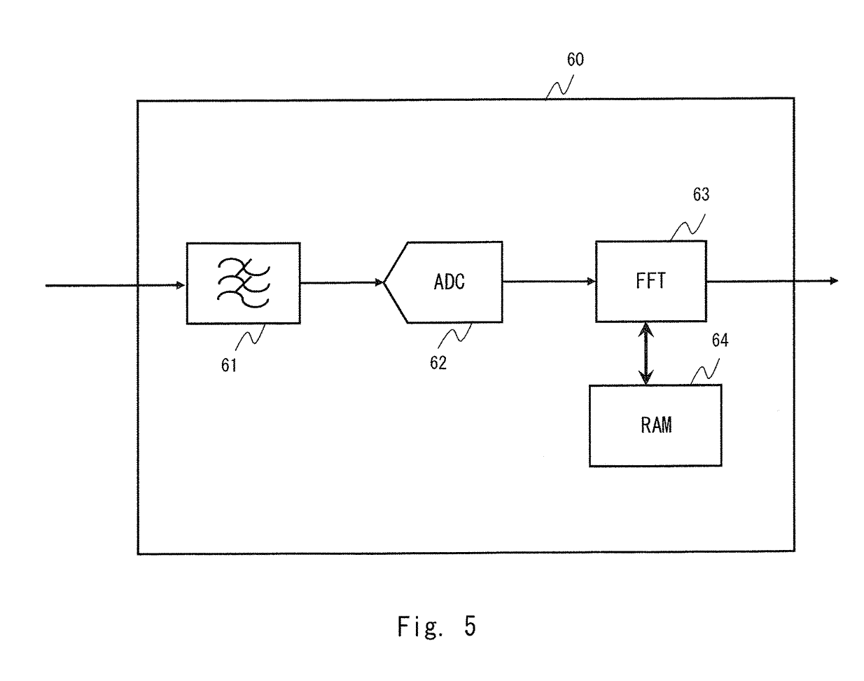

Subsequently, another configuration example of the energy detection unit 30 according to the first exemplary embodiment of the present invention will be described with reference to FIG. 5. The energy detection unit 30 includes a filter 61, an AD converter 62, a fast Fourier transform unit (FFT) 63, and a memory 64. The band of each of the filter 61 and the AD converter 62 is set to be wider than that of the variable filter 31 and the AD converter 33 shown in FIG. 3. The fast Fourier transform unit 63 calculates an input frequency and a series of signal intensity at the frequency by using a digital signal output from the AD converter 62. Note that the fast Fourier transform unit 63 can enhance the accuracy of detecting the signal intensity by increasing the number of FET points.

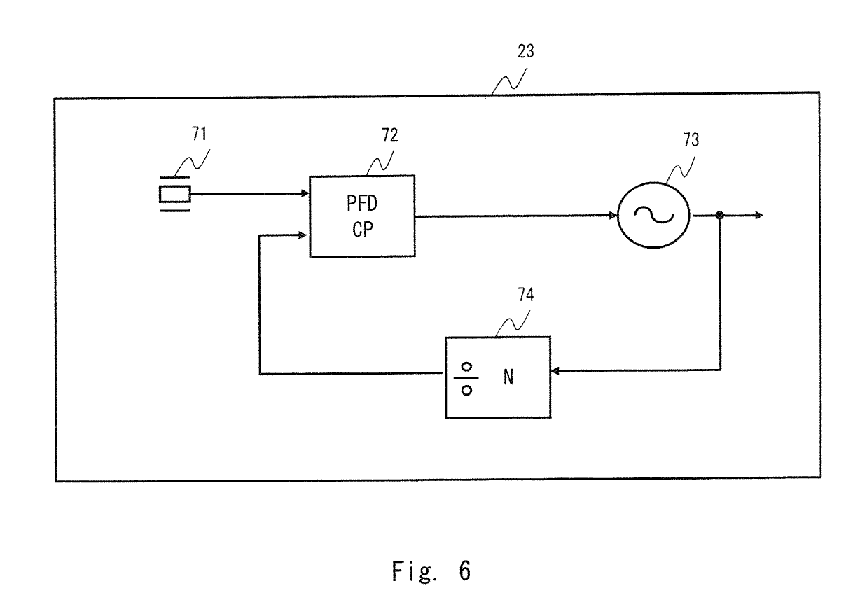

Subsequently, a configuration example of the oscillator 23 according to the first exemplary embodiment of the present invention will be described with reference to FIG. 6. The oscillator to be described with reference to FIG. 6 is formed of a PLL (Phase Locked Loop). The oscillator 23 is formed of a feedback loop including a crystal oscillator 71 which generates a reference frequency, a phase comparator/charge pump 72, a voltage control oscillator 73, and a frequency divider 74.

The phase comparator/charge pump 72 converts a phase difference between a reference frequency signal output from the crystal oscillator 71 and an output signal output from the frequency divider 74 into voltage, and outputs the voltage to the voltage control oscillator 73. The voltage control oscillator 73 outputs frequency signals having different values according to the voltage value received from the phase comparator/charge pump 72. The frequency divider 74 divides the frequency of each frequency signal output from the voltage control oscillator 73 at a frequency division ratio that can be switched. Thus, the output frequency can be switched by switching the frequency division ratio of the frequency divider 74. Note that the output frequency can be switched in the same manner as in the oscillator shown in FIG. 6 even when the frequency divider 74 is disposed at the subsequent stage of the voltage control oscillator 73 or at the preceding stage of the phase comparator/charge pump 72.

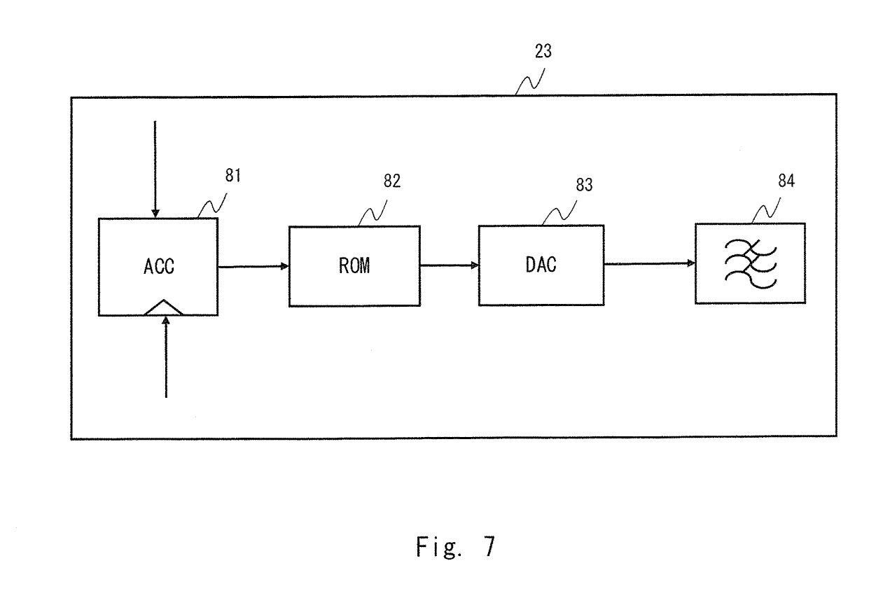

FIG. 7 shows another configuration example of the oscillator 23 according to the first exemplary embodiment of the present invention. The oscillator 23 shown in FIG. 7 is formed of a DDS (Direct Digital Synthesizer), and is configured by connecting an accumulator (ACC) 81, a memory (ROM) 82, a DA converter (DAC) 83, and a filter 84 in this order. At this time, the output frequency can be switched by switching values of step P which is cumulatively added in the accumulator 81, or by switching a clock signal having an operating frequency of the accumulator. The accumulator reads the cumulatively added values of step P with a constant clock timing, and outputs the read values to the memory 82. The DA converter 83 converts the digital data held in the memory 82 into analog data. The filter 84 removes clock components from the waveform of the analog data output from the DA converter 83, and outputs the analog data.

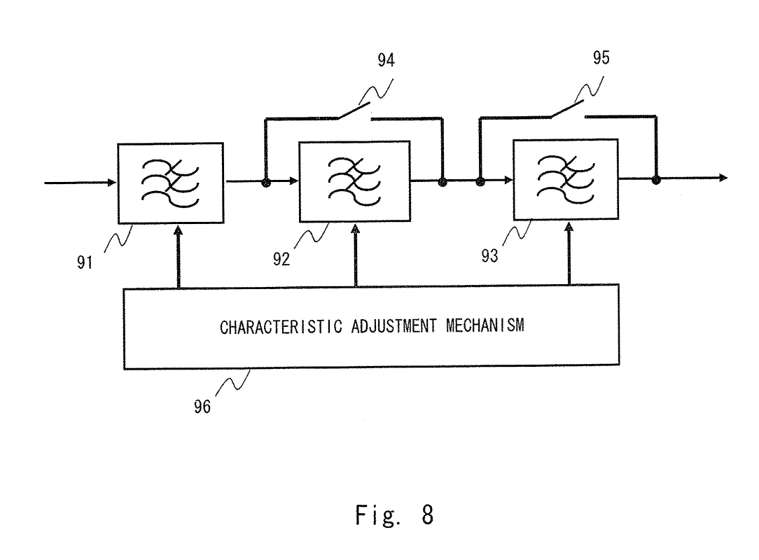

Subsequently, a configuration example of the variable filter 24 according to the first exemplary embodiment of the present invention will be described with reference to FIG. 8. In the variable filter 24, a sub-filter 92 with a switch 94 and a sub-filter 93 with a switch 95 are connected at the subsequent stage of a sub-filter 91. Assuming that the order of each sub-filter is the second order, the order of the entire filter can be switched to the second order, the fourth order, and the sixth order by switching ON/OFF of the switches 94 and 95. The switches 94 and 95 are switched by the control signal notified from the energy detection unit 30. For example, the energy detection unit 30 performs control to increase the number of sub-filters to be activated when the power intensity in the frequency band near the frequency band used for the desired signal is larger than a predetermined value, and to reduce the number of sub-filters to be activated when the power intensity in the frequency band near the frequency band used for the desired signal is smaller than the predetermined value. Further, each sub-filter is connected to a characteristic adjustment mechanism 96. This enables switching of the bandwidth of each filter. The energy detection unit 30 controls the bandwidth of each filter to become relatively narrower, when the power intensity in the frequency band near the frequency band used for the desired signal is larger than the predetermined value. The energy detection unit 30 controls the bandwidth of each filter to become relatively wider, when the power intensity in the frequency band near the frequency band used for the desired signal is smaller than the predetermined value. A variable capacitative element, a variable resistive element, a variable transconductance circuit, or a duty variable circuit, for example, is used as the characteristic adjustment mechanism 96.

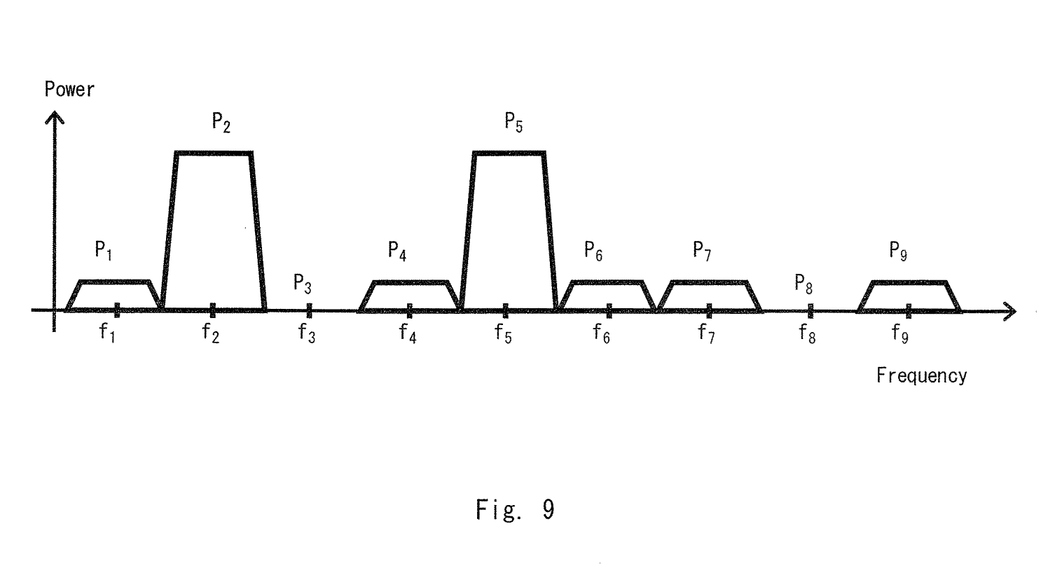

Subsequently, relations between frequency bands and power intensities of radio signals acquired in the energy detection unit 30 according to the first exemplary embodiment of the present invention will be described with reference to FIG. 9.

In FIG. 9, a desired signal frequency is not determined in advance. If there is a vacant channel, that is, no power is detected, at a certain time, the desired signal frequency can be set in any channel between frequencies f₁ to f₉. The term “channel” refers to a frequency bandwidth of a communication line for use in transmitting radio signals. Such a radio system is a system called cognitive radio, as typified by IEEE 802.22, IEEESCC41, or the like using vacant frequencies of television.

The cognitive radio is required to determine whether the frequencies are used or not by micro-power detection called spectrum sensing. For example, the detection accuracy is equal to or lower than −116 dBm in a band of 6 MHz per channel in IEEE802.22. A two-step sensing method is proposed to perform spectrum sensing of such micro power over a wide band. Specifically, at a first step, energy detection (or blind detection) that allows high-speed detection is carried out, while the detection sensitivity is slightly low. Next, in a second step, feature detection that allows detection with high accuracy is carried out. Note that the feature detection in the latter step is generally achieved by large-scale digital processing requiring a long period of time.

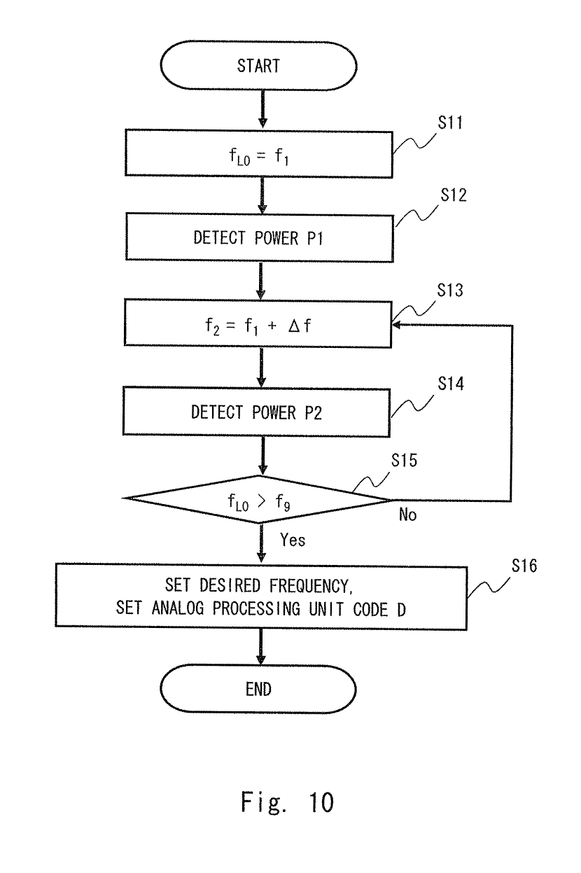

Subsequently, a flow of processing for determining the desired signal frequency according to the first exemplary embodiment of the present invention will be described with reference to FIG. 10. Here, an application to the cognitive radio is described by way of example by using the signal shown in FIG. 9.

First, a frequency f_{LO} of the oscillator 23 is set to the minimum frequency f₁ (S11), and power P₁ is detected by the energy detection unit 30 (S12). Next, the frequency of the oscillator 23 is increased by Δf according to the control signal from the energy detection unit 30, and is set to f₂ (S13). Thus, power P₂ is detected in the energy detection unit 30 (S14). The power detection as described above is repeated until completion of the power detection for the frequency f₉ (S15). Though the power detection is sequentially carried out from the minimum frequency to the maximum frequency in this case, the order of frequencies can be arbitrarily set, and the frequency step Δf can be finely set.

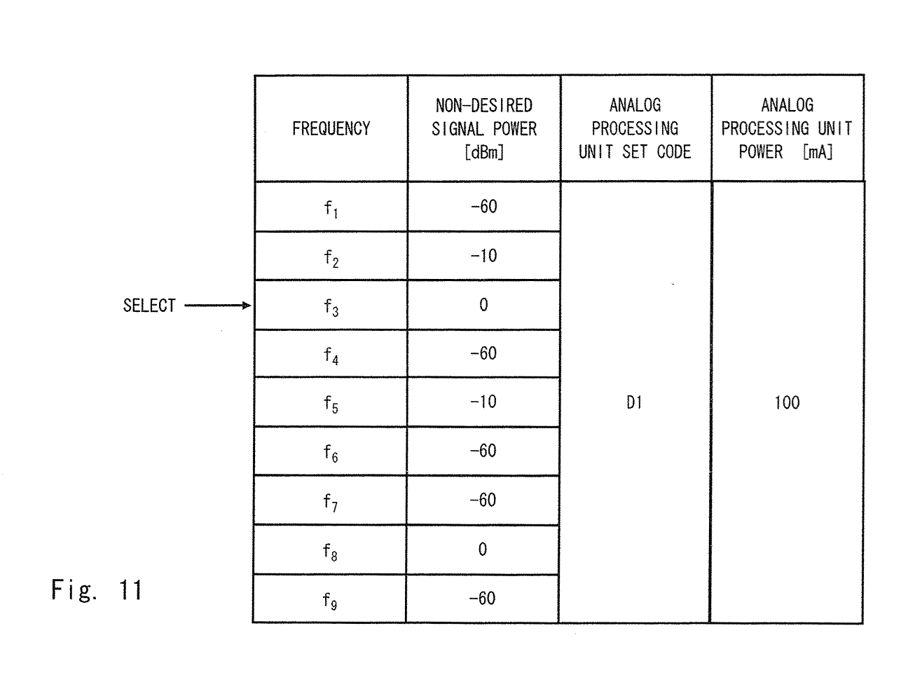

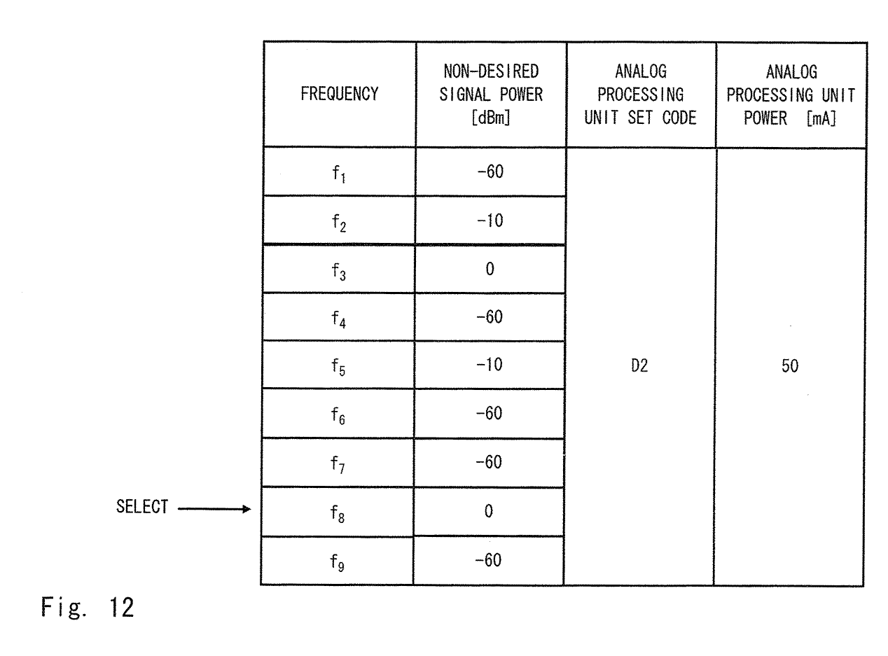

Next, the frequency band of the desired signal and the control signal of the analog processing unit are determined depending on the detected power intensity (S16). The processing for determining the frequency band of the desired signal and the control signal of the analog processing unit is periodically carried out. Thus, the frequency band of the desired signal and the control signal of the analog processing unit can be determined depending on a change in power intensity. Specifically, the processing for determining the desired frequency signal in the case of the example shown in FIG. 9 will be described. FIGS. 11 and 12 are data tables that manage, in a manner correlated with each other, the frequencies and the detected power intensities shown in FIG. 9. The power detected at each of the frequencies f₄, f₆, f₇, and f₉ is −60 dBm, and the power detected at each of the frequencies f₂ and f₅ is −10 dBm. No power is detected at the frequencies f₃ and f₈. Thus, one of the third channel frequency f₃ and the eighth channel frequency f₈, at each of which no power is detected, is selected as the frequency band of the desired signal. In this case, however, assume that the frequencies f₃ and f₈ are defined as vacant frequencies by the feature detection.

When the frequency f₃ is selected as the frequency of the desired signal (FIG. 11), the power P₂ of the adjacent channel frequency f₂ is large, so that a control signal (for example, D1) that alleviates the effect of an interfering signal from the frequency f₂ is selected as a set code of the analog processing unit 20. The “control signal D1 that alleviates the effect” herein described corresponds to a signal for controlling the order of the variable filter 24 to be increased or controlling the filter band to be decreased in the present invention. The current consumption of the analog processing unit 20 is relatively increased by increasing the order of the filter or decreasing the filter band.

On the other hand, in the case of selecting the frequency f₈ as the desired signal frequency (FIG. 12), the power of each of the adjacent channel frequency and the channel frequency subsequent to the adjacent channel frequency and the channel frequency adjacent to the adjacent channel frequency is small. Accordingly, there is no need for setting to alleviate the effect described above. That is, since the control is performed such that the order of the filter is reduced and the band is increased, a control signal D2 is selected as the set code of the analog processing unit 20. This enables the analog processing unit 20 to operate while reducing the power consumption. In this case, the current consumption in the analog processing unit 20 is set to 100 mA when the frequency f₃ is selected, and the current consumption in the analog processing unit 20 is set to 50 mA when the frequency f₈ is selected. Therefore, in the case of this example, the frequency f₈ is selected as the desired signal frequency in view of a reduction in current consumption of the analog processing unit 20.

Note that in the selection of the desired signal frequency described above, the power intensities of the frequencies f₁ to f₉ are not remeasured after the extraction of the frequencies f₃ and f₈ at which no power is detected, and the power intensity values used to extract the frequencies f₃ and f₈ are used. Thus, it is only necessary to measure the power intensities once. This contributes to a reduction in time for selecting the desired signal frequency as compared with the case of measuring the power intensities multiple times.

With this configuration, the cognitive radio system for reducing power consumption can be achieved by reflecting the detection results of the power intensities in the nearby frequencies including the adjacent channel frequency and the channel frequency subsequent to the adjacent channel frequency, upon determination of the desired signal frequency. Furthermore, the same energy detection unit can detect the presence or absence of vacant frequencies and the intensity of the interfering signal, thereby reducing the overheads of circuits and operation time.

### Second Exemplary Embodiment

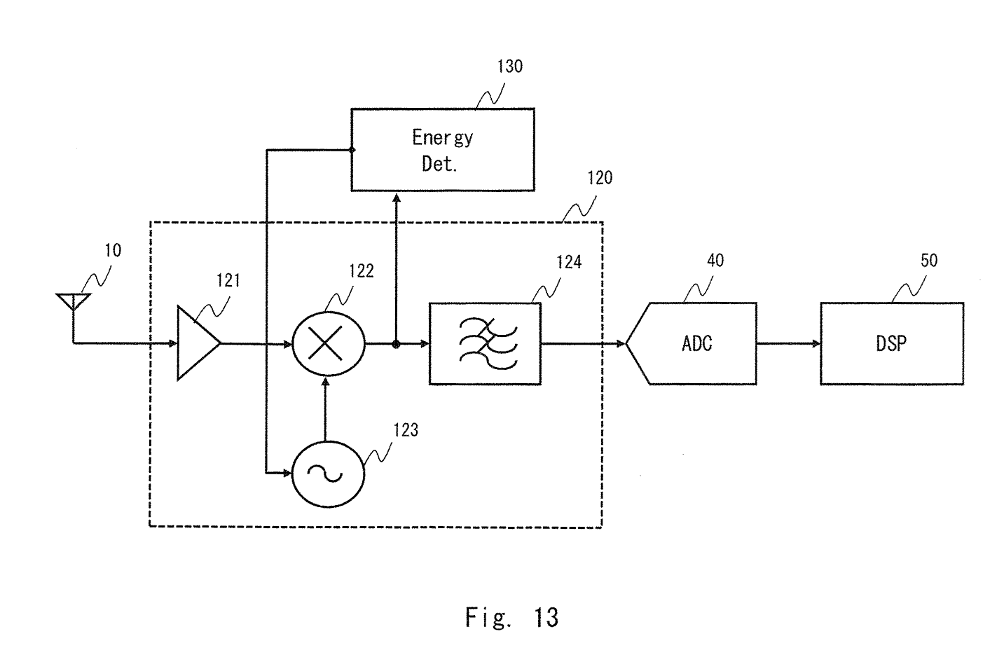

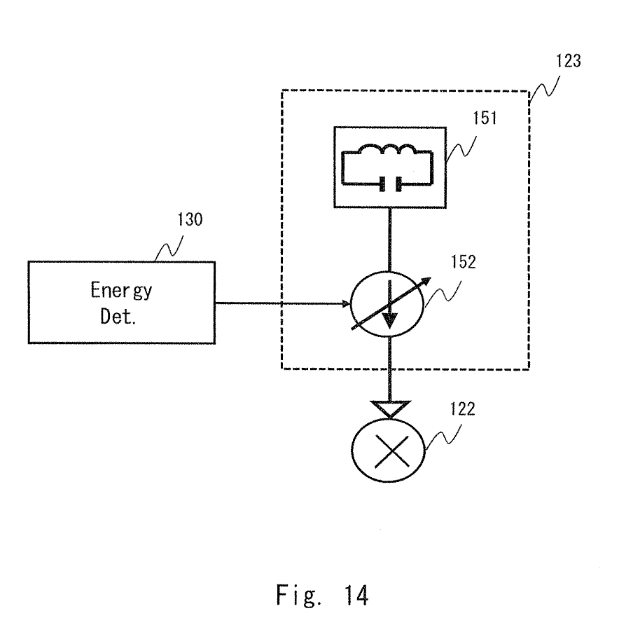

Subsequently, a configuration example of a signal processing circuit according to a second exemplary embodiment of the present invention will be described with reference to FIG. 13. FIG. 13 differs from FIG. 2 in the configuration in which an energy detection unit 130 and a variable filter 124 are not connected. The other components of FIG. 13 are similar to those of FIG. 2, so a detailed description thereof is omitted. The signal processing circuit shown in FIG. 13 controls phase noise generated in an oscillator 123 according to the signal power intensity of an interfering signal. Here, a configuration example of the oscillator 123 will be described with reference to FIG. 14.

The oscillator shown in FIG. 14 includes a current control oscillator core unit 151 and a current adjustment mechanism 152. The current control oscillator core unit 151 outputs frequency signals having different values depending on the value of flowing current. In this case, when the flowing current is decreased, the phase noise generated in the current control oscillator core unit 151 increases. On the other hand, when the flowing current is increased, the phase noise decreases. Accordingly, when the power intensity of the interfering signal is high in the energy detection unit 130, the current adjustment mechanism 152 is adjusted to increase the current flowing through the current control oscillator core unit 151. When the power intensity of the interfering signal is low, control is performed to decrease the current flowing through the current control oscillator core unit 151. The frequency signals output from the current control oscillator core unit 151 are input to a mixer 122. The current adjustment mechanism 152 is configured by connecting in parallel a plurality of MOS transistors to be switched and controlled, for example.

As described above, the use of the oscillator 123 according to the second exemplary embodiment of the present invention enables switching of the phase noise according to the power intensity of the interfering signal. Consequently, when the power intensity of the interfering signal is relatively low, the current consumption in the oscillator 123 can be suppressed.

### Third Exemplary Embodiment

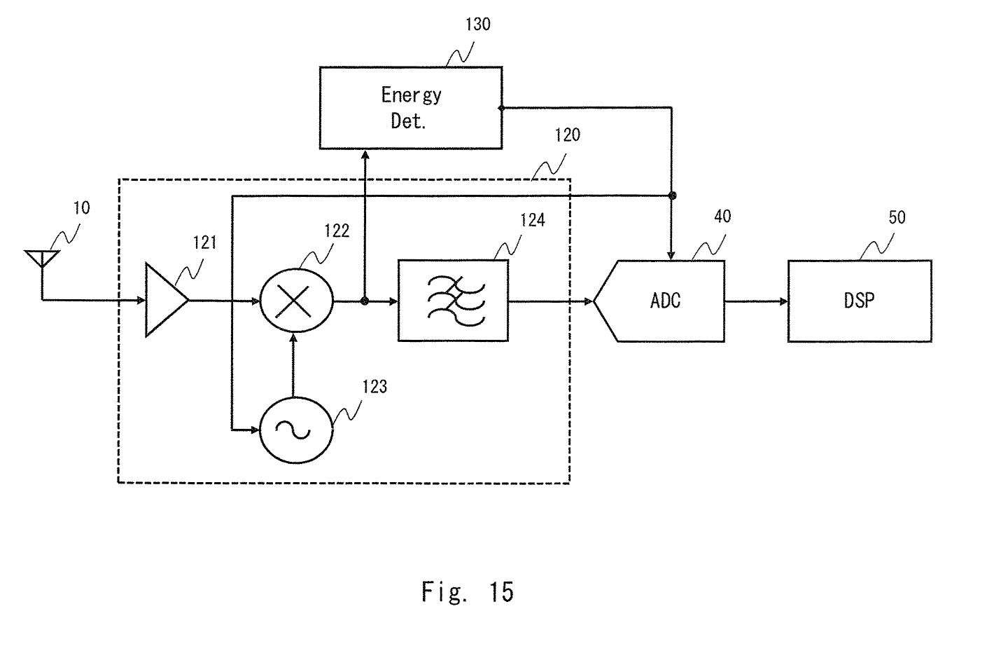

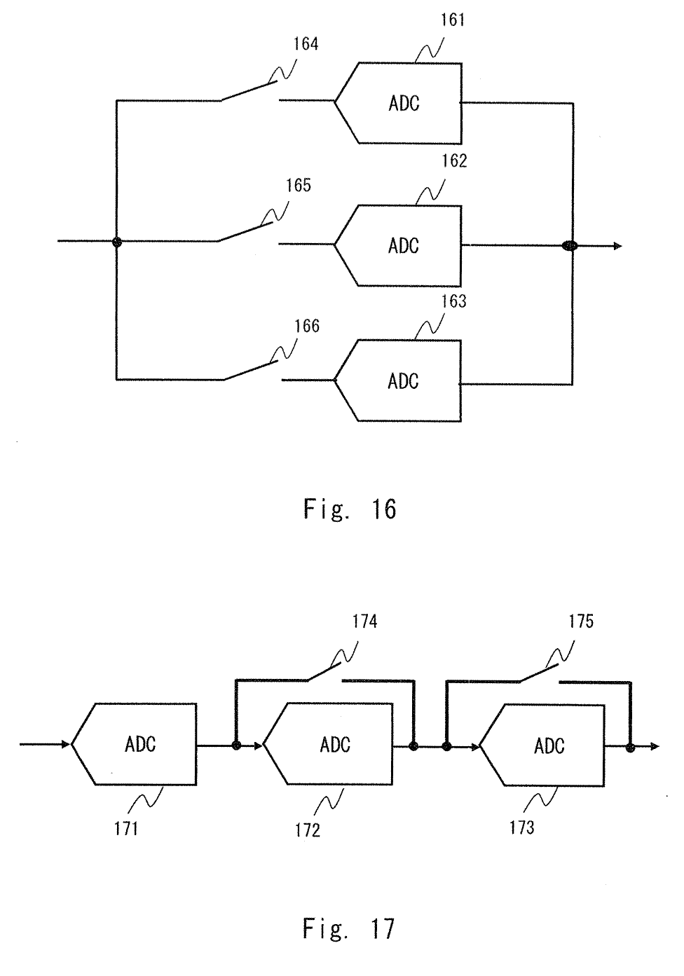

Subsequently, a configuration example of a signal processing circuit according to a third exemplary embodiment of the present invention will be described with reference to FIG. 15. FIG. 15 differs from FIG. 13 in that the energy detection unit 130 controls the AD converter 40. The other components are similar to those of FIG. 13, so a detailed description thereof is omitted. Referring next to FIG. 16, a configuration example of the AD converter 40 according to the third exemplary embodiment of the present invention will be described. The AD converter 40 is configured by connecting in parallel a sub-AD converter 161 with a switch 164, a sub-AD converter 162 with a switch 165, and a sub-AD converter 163 with a switch 166. Assuming herein that the sub-AD converters have different numbers of conversion bits, the number of conversion bits of the AD converter can be switched by turning on any of the switches 164 to 166.

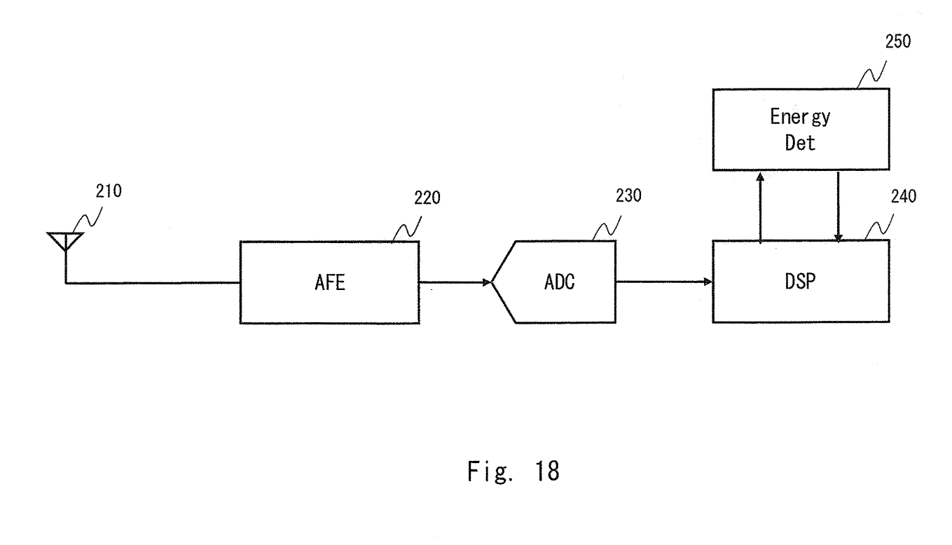

Alternatively, as shown in FIG. 17, a configuration may be adopted in which a sub-AD converter 171, a sub-AD converter 172 with a switch 174 and a sub-AD converter 173 with a switch 175 are connected in series. In this case, assuming that the number of conversion bits of each of the sub-AD converters is four, for example, the number of conversion bits is increased to 12 by turning on all the switches. On the other hand, when all the switches are turned off, the number of conversion bits is four. Such a configuration is suitable for a pipeline-type AD converter.

Subsequently, operation of the signal processing circuit shown in FIG. 15 will be described. The energy detection unit 130 switches the switches of the sub-AD converters according to the signal power intensity of the interfering signal. For example, in the AD converter shown in FIG. 16, the switch of the sub-AD converter having the largest number of conversion bits is turned on when the power intensity of the interfering signal is large. Further, when the power intensity of the interfering signal is small, the switch of the sub-AD converter having the smallest number of conversion bits is turned on. In the AD converter shown in FIG. 17, when the power intensity of the interfering signal is large, the switches 174 and 175 are turned off and all the sub-AD converters are activated. When the power intensity of the interfering signal is small, at least one of the switches 174 and 175 is turned on to reduce the number of sub-AD converters to be activated. The determination as to the magnitude of the power intensity of the interfering signal may be carried out using a predetermined threshold. The switches of the sub-AD converters are controlled based on the control signal notified from the energy detection unit 130.

As described above, the use of the AD converter according to the third exemplary embodiment of the present invention enables change of the number of conversion bits according to the power intensity of the interfering signal. Consequently, when the power intensity of the interfering signal is relatively low, the current consumption in the AD converter 40 can be suppressed.

The whole or part of the exemplary embodiments disclosed above can be described as, but not limited to, the following supplementary notes.

(Supplementary note 1) A signal processing circuit comprising: a power acquisition unit that receives a plurality of radio signals transmitted with different frequency bands and acquires a power intensity of each of the radio signals received; and a frequency selection unit that selects, from among frequency bands used for radio signals having the power intensity lower than a predetermined power intensity, a frequency band having a relatively low power intensity in a frequency band near the frequency bands as each frequency band in which communication is executed.
(Supplementary note 2) The signal processing circuit according to Supplementary note 1, wherein the frequency selection unit extracts a frequency band used for the radio signals having the power intensity lower than the predetermined intensity, based on the power intensity acquired by the power acquisition unit, and selects, as each frequency band in which the communication is executed, a frequency band having a relatively low power intensity in a frequency band near the extracted frequency band, by using a power intensity used to extract the frequency band, without remeasuring the power intensity of each radio signal using frequency bands other than the extracted frequency band.
(Supplementary note 3) The signal processing circuit according to Supplementary note 1 or 2, wherein the power acquisition unit controls frequency bands used for a filter for the received radio signals according to the acquired power intensity.
(Supplementary note 4) The signal processing circuit according to Supplementary note 3, wherein the power acquisition unit controls a filter provided in an analog signal processing unit that processes the radio signals into analog signals.
(Supplementary note 5) The signal processing circuit according to Supplementary note 3 or 4, wherein the power acquisition unit relatively decreases a frequency bandwidth of output data output from the filter when the power intensity in the frequency band near the frequency band in which the communication is executed is larger than a predetermined value, and relatively increases the frequency bandwidth of the output data when the power intensity in the frequency band near the frequency band in which the communication is executed is smaller than the predetermined value.
(Supplementary note 6) The signal processing circuit according to any one of Supplementary notes 3 to 5, wherein the filter includes a plurality of sub-filters having different damping properties, and the signal processing control unit controls the number of the sub-filters to be activated according to the power intensity in the frequency band near the frequency band in which the communication is executed, and adjusts an amount of removed interfering signals using frequencies interfering with the frequency band in which the communication is executed.
(Supplementary note 7) The signal processing circuit according to any one of Supplementary notes 3 to 6, further comprising an amplification unit that amplifies an amplitude of each of the radio signals, wherein the power acquisition unit amplifies the amplitude of each of the radio signals to be relatively large when the power intensity in the frequency band near the frequency band in which the communication is executed is larger than the predetermined value, and amplifies the amplitude of each of the radio signals to be relatively small when the power intensity in the frequency band near the frequency band in which the communication is executed is smaller than the predetermined value.
(Supplementary note 8) The signal processing circuit according to any one of Supplementary notes 3 to 7, further comprising a digital signal conversion unit that converts a signal output from the analog signal processing unit into a digital signal, wherein the signal processing control unit relatively increases the number of quantized bits of the digital signal in the digital signal conversion unit when the power intensity in the frequency band near the frequency band used for the desired signal is larger than the predetermined value, and relatively decreases the number of quantized bits of the digital signal in the digital signal conversion unit when the power intensity in the frequency band near the frequency band used for the desired signal is smaller than the predetermined value.
(Supplementary note 9) The signal processing circuit according to any one of Supplementary notes 3 to 8, wherein the power acquisition unit decreases phase noise in an oscillation unit that oscillates a plurality of local signals to be activated with different frequencies when the power intensity in the frequency band near the frequency band in which the communication is executed is larger than the predetermined value, and increases the phase noise in the oscillation unit when the power intensity in the frequency band near the frequency band in which the communication is executed is smaller than the predetermined value.
(Supplementary note 10) A wireless communication device comprising: a power acquisition unit that receives a plurality of radio signals transmitted with different frequency bands and acquires a power intensity of each of the radio signals received; a frequency selection unit that selects, from among frequency bands used for radio signals having the power intensity lower than a predetermined power intensity, a frequency band having a relatively low power intensity in a frequency band near the frequency bands as each frequency band in which communication is executed; and a communication unit that notifies a counterpart communication device of the selected frequency band.
(Supplementary note 11) A signal processing method comprising the steps of: receiving a plurality of radio signals transmitted with different frequency bands and acquiring a power intensity of each of the radio signals received; and selecting, from among frequency bands used for radio signals having the power intensity lower than a predetermined power intensity, a frequency band having a relatively low power intensity in a frequency band near the frequency bands as each frequency band in which communication is executed.

Note that the present invention is not limited to the above exemplary embodiments, but can be modified as appropriate without departing from the scope of the invention.

The present invention has been described above with reference to exemplary embodiments, but the present invention is not limited to the above embodiments. The configuration and details of the present invention can be changed in various manners which can be understood by those skilled in the art within the scope of the invention.

This application is based upon and claims the benefit of priority from Japanese patent application No. 2010-039903, filed on Feb. 25, 2010, the disclosure of which is incorporated herein in its entirety by reference.

### REFERENCE SIGNS LIST

1 WIRELESS COMMUNICATION DEVICE
2 COMMUNICATION UNIT
3 SIGNAL PROCESSING CIRCUIT
4 POWER ACQUISITION UNIT
5 FREQUENCY SELECTION UNIT
10 ANTENNA
20 ANALOG PROCESSING UNIT
21 AMPLIFIER
22 MIXER
23 OSCILLATOR
24 VARIABLE FILTER
30 ENERGY DETECTION UNIT
31 VARIABLE FILTER
32 SQUARE-LAW DETECTION UNIT
33 AD CONVERTER
34 DIGITAL PROCESSING UNIT
35 MEMORY
40 AD CONVERTER
50 DIGITAL PROCESSING UNIT
61 FILTER
62 AD CONVERTER
63 FAST FOURIER TRANSFORM UNIT
64 MEMORY
71 CRYSTAL OSCILLATOR
72 PHASE COMPARATOR/CHARGE PUMP
73 VOLTAGE CONTROL OSCILLATOR
74 FREQUENCY DIVIDER
81 ACCUMULATOR
82 MEMORY
83 DA CONVERTER
84 FILTER
91 SUB-FILTER
92 SUB-FILTER
93 SUB-FILTER
94 SWITCH
95 SWITCH
96 CHARACTERISTIC ADJUSTMENT MECHANISM
120 ANALOG PROCESSING UNIT
121 AMPLIFIER
122 MIXER
123 OSCILLATOR
124 VARIABLE FILTER
130 ENERGY DETECTION UNIT
151 CURRENT CONTROL OSCILLATOR CORE UNIT
152 CURRENT ADJUSTMENT MECHANISM
161 SUB-AD CONVERTER
162 SUB-AD CONVERTER
163 SUB-AD CONVERTER
164 SWITCH
165 SWITCH
166 SWITCH

1. A signal processing circuit comprising:
a power acquisition unit that receives a plurality of radio signals transmitted with different frequency bands and acquires a power intensity of each of the radio signals received; and
a frequency selection unit that selects, from among frequency bands used for radio signals having the power intensity lower than a predetermined power intensity, a frequency band having a relatively low power intensity in a frequency band near the frequency bands as each frequency band in which communication is executed.

2. The signal processing circuit according to claim 1, wherein the frequency selection unit extracts a frequency band used for the radio signals having the power intensity lower than the predetermined power intensity, based on the power intensity acquired by the power acquisition unit, and selects, as each frequency band in which the communication is executed, a frequency band having a relatively low power intensity in a frequency band near the extracted frequency band, by using a power intensity used to extract the frequency band, without remeasuring the power intensity of each radio signal using frequency bands other than the extracted frequency band.

3. The signal processing circuit according to claim 1, wherein the power acquisition unit controls frequency bands used for a filter for the received radio signals according to the acquired power intensity.

4. The signal processing circuit according to claim 3, wherein the power acquisition unit controls a filter provided in an analog signal processing unit that processes the radio signals into analog signals.

5. The signal processing circuit according to claim 3, wherein the power acquisition unit relatively decreases a frequency bandwidth of output data output from the filter when the power intensity in the frequency band near the frequency band in which the communication is executed is larger than a predetermined value, and relatively increases the frequency bandwidth of the output data when the power intensity in the frequency band near the frequency band in which the communication is executed is smaller than the predetermined value.

6. The signal processing circuit according to claim 3, wherein
the filter includes a plurality of sub-filters having different damping properties, and
the power acquisition unit controls the number of the sub-filters to be activated according to the power intensity in the frequency band near the frequency band in which the communication is executed, and adjusts an amount of removed interfering signals using frequencies interfering with the frequency band in which the communication is executed.

7. The signal processing circuit according to claim 3, wherein the power acquisition unit decreases phase noise in oscillator that oscillates a plurality of local signals to be activated with different frequencies when the power intensity in the frequency band near the frequency band in which the communication is executed is larger than the predetermined value, and increases the phase noise in the oscillator when the power intensity in the frequency band near the frequency band in which the communication is executed is smaller than the predetermined value.

8. The signal processing circuit according to claim 3, further comprising a digital signal conversion unit that converts a signal output from the analog signal processing unit into a digital signal,
wherein the power acquisition unit relatively increases the number of quantized bits of the digital signal in the digital signal conversion unit when the power intensity in the frequency band near the frequency band used for a desired signal is larger than the predetermined value, and relatively decreases the number of quantized bits of the digital signal in the digital signal conversion unit when the power intensity in the frequency band near the frequency band used for the desired signal is smaller than the predetermined value.

9. A wireless communication device comprising:
a power acquisition unit that receives a plurality of radio signals transmitted with different frequency bands, and acquires a power intensity of each of the radio signals received;
a frequency selection unit that selects, from among frequency bands used for radio signals having the power intensity lower than a predetermined power intensity, a frequency band having a relatively low power intensity in a frequency band near the frequency bands as each frequency band in which communication is executed; and
a communication unit that notifies a counterpart communication device of the selected frequency band.

10. A signal processing method comprising:
receiving a plurality of radio signals transmitted with different frequency bands and acquiring a power intensity of each of the radio signals received; and
selecting, from among frequency bands used for radio signals having the power intensity lower than a predetermined power intensity, a frequency band having a relatively low power intensity in a frequency band near the frequency bands as each frequency band in which communication is executed.

11. The signal processing circuit according to claim 2, wherein the power acquisition unit controls frequency bands used for a filter for the received radio signals according to the acquired power intensity.

12. The signal processing circuit according to claim 4, wherein the power acquisition unit relatively decreases a frequency bandwidth of output data output from the filter when the power intensity in the frequency band near the frequency band in which the communication is executed is larger than a predetermined value, and relatively increases the frequency bandwidth of the output data when the power intensity in the frequency band near the frequency band in which the communication is executed is smaller than the predetermined value.

13. The signal processing circuit according to claim 4, wherein
the filter includes a plurality of sub-filters having different damping properties, and
the power acquisition unit controls the number of the sub-filters to be activated according to the power intensity in the frequency band near the frequency band in which the communication is executed, and adjusts an amount of removed interfering signals using frequencies interfering with the frequency band in which the communication is executed.

14. The signal processing circuit according to claim 5, wherein
the filter includes a plurality of sub-filters having different damping properties, and
the power acquisition unit controls the number of the sub-filters to be activated according to the power intensity in the frequency band near the frequency band in which the communication is executed, and adjusts an amount of removed interfering signals using frequencies interfering with the frequency band in which the communication is executed.

15. The signal processing circuit according to claim 4, wherein the power acquisition unit decreases phase noise in oscillator that oscillates a plurality of local signals to be activated with different frequencies when the power intensity in the frequency band near the frequency band in which the communication is executed is larger than the predetermined value, and increases the phase noise in the oscillator when the power intensity in the frequency band near the frequency band in which the communication is executed is smaller than the predetermined value.

16. The signal processing circuit according to claim 5, wherein the power acquisition unit decreases phase noise in oscillator that oscillates a plurality of local signals to be activated with different frequencies when the power intensity in the frequency band near the frequency band in which the communication is executed is larger than the predetermined value, and increases the phase noise in the oscillator when the power intensity in the frequency band near the frequency band in which the communication is executed is smaller than the predetermined value.

17. The signal processing circuit according to claim 6, wherein the power acquisition unit decreases phase noise in oscillator that oscillates a plurality of local signals to be activated with different frequencies when the power intensity in the frequency band near the frequency band in which the communication is executed is larger than the predetermined value, and increases the phase noise in the oscillator when the power intensity in the frequency band near the frequency band in which the communication is executed is smaller than the predetermined value.

18. The signal processing circuit according to claim 4, further comprising a digital signal conversion unit that converts a signal output from the analog signal processing unit into a digital signal,
wherein the power acquisition unit relatively increases the number of quantized bits of the digital signal in the digital signal conversion unit when the power intensity in the frequency band near the frequency band used for a desired signal is larger than the predetermined value, and relatively decreases the number of quantized bits of the digital signal in the digital signal conversion unit when the power intensity in the frequency band near the frequency band used for the desired signal is smaller than the predetermined value.

19. The signal processing circuit according to claim 5, further comprising
a digital signal conversion unit that converts a signal output from the analog signal processing unit into a digital signal,
wherein the power acquisition unit relatively increases the number of quantized bits of the digital signal in the digital signal conversion unit when the power intensity in the frequency band near the frequency band used for a desired signal is larger than the predetermined value, and relatively decreases the number of quantized bits of the digital signal in the digital signal conversion unit when the power intensity in the frequency band near the frequency band used for the desired signal is smaller than the predetermined value.

20. The signal processing circuit according to claim 6, further comprising a digital signal conversion unit that converts a signal output from the analog signal processing unit into a digital signal,
wherein the power acquisition unit relatively increases the number of quantized bits of the digital signal in the digital signal conversion unit when the power intensity in the frequency band near the frequency band used for a desired signal is larger than the predetermined value, and relatively decreases the number of quantized bits of the digital signal in the digital signal conversion unit when the power intensity in the frequency band near the frequency band used for the desired signal is smaller than the predetermined value.
